(19) United States
(12) Patent Application Publication
(10) Pub. No.: US 2016/0260168 A1
(43) Pub. Date: Sep. 8, 2016

(54) METHOD AND APPARATUS FOR SEPARATING DISPARATE MANUFACTURED PRODUCTS INTO COMMODITY AND NON-COMMODITY COMPONENTS

(71) Applicant: Silicon Valley Commodities Exchange, Inc., Cupertino, CA (US)

(72) Inventor: Robert M. GRISWOLD, Cupertino, CA (US)

(21) Appl. No.: 14/637,197

(22) Filed: Mar. 3, 2015

(51) Int. Cl. G06Q 40/04

(52) U.S. Cl. CPC G06Q 40/04

(57) ABSTRACT

Disparate manufactured electronic products are separated into a commodity component comprising a common, atomic functional value and a non-commodity component. Technical commodities are analyzed for manufactured electronic products, such as different models of disk drives produced by different manufacturers, that have disparate capacity, access times, and form factors, and a common unit of functional value is produced for each product to allow for the purchase and sale of such products as commodities.

### FIELD

The invention relates to the creation of technical commodities. More particularly, the invention relates to a separating disparate manufactured products into commodity and non-commodity components and creating a market therefor.

### BACKGROUND

True markets for a commodity component of manufactured electronic products, i.e. where commodity values are assigned to a commodity portion of manufactured electronic products, do not exist. While such commodities as wheat and pork bellies are known and, as such, allow for the predictable purchase and sale of same through efficient physical and derivative markets, manufactured electronic products are sold and purchased without regard to functional unit values. For example, hard disk drives (HDDs) are useful for storing information and such drives each have a defined ability to store information referred to as the drive's capacity, which is typically expressed in gigabytes. However, it is presently not possible to assess the value of an HDD based upon capacity alone because many other factors affect the sales price of such drives including, for example, form factor, manufacturer warranty terms, interface type, firmware features, access time, and the like.

In the foregoing example consider the HDD industry and their customers. Factors that add uncertainty to such industry include capital intensity due to uncertain demand. Capital expenditure decisions are made well in advance to accommodate manufacturing lead times yet there are inconsistent demand and supply expectations, poor demand visibility and forecast accuracy, no incentives or mechanisms for demand to declare, poor pricing visibility, and wide pricing variations between customer types. In such industry, pricing is haphazard due, in part, to opaquely negotiated long term agreements (LTA's) and an illiquid spot market; OEM negotiations are opaque, not cost aligned; and the distributor (“Spot”) market is volatile and inconsistently priced, e.g. ˜20% above forward, where price agreements reduce visibility further, and where grey market incentives cloud true pricing.

In the example of HDDs, value chain participants have similar basic needs (see FIG. 1 and Table 1 below)

TABLE 1
HDD Value Chain Participants Basic Needs

| Basic | HDD | HW/Storage | Disti/ | Cloud |
|---|---|---|---|---|
| Needs | Manufacturer | OEM | VAR | Service |
| Price | Pricing trends in | Pricing | Pricing trends | Pricing |
| Transparency/ | market | trends in | in market | trends in |
| Discovery | Price | market | Monitor price | market |
| | competitiveness | HDD costs | ratios (e.g. 2.5″ | Price |
| | Monitor price | vs. | vs. 3.5″) | competitiveness |
| | ratios (e.g. 2.5″ | competitors | | |
| | vs. 3.5″) | | | |
| Short- | Prices vs. share | Ensure fair | Ensure fair | Ensure |
| Term | levels | pricing vs. | pricing vs. | fair |
| Negotiation | View of true TAM | competitors | competitors for | pricing |
| Optimization | Understanding of | for volume | volume levels | vs. |
| | price levels | levels | | competitors |
| | required for | | | for |
| | business | | | volume |
| | | | | levels |
| Long- | Market | Hedge | Opportunity to | Hedge |
| Term | expectations for | storage cost | speculate and | storage |
| Forecasting/ | volumes & price | risk in | take advantage | cost risk |
| Risk | levels | long-term | of short-term | in long- |
| Hedging | Estimates to drive | bids | discrepancies in | term |
| | capacity planning | | prices | infrastructure |
| | | | | build- |
| | | | | outs |

Thus, inefficiencies and friction throughout the HDD value chain create real pain-points. For component suppliers there is poor forecast accuracy, capital expenditure uncertainty, and misaligned manufacturing capacity; for HDD manufacturers, there is uncertain supply chain cost management, poor demand signals, poor forecast accuracy, uncertain capital expenditure plans, late quarter pushes, incomplete and untimely competitive visibility, chasing down prices unrelated to supply and demand, wide variance in prices, and high sales and marketing costs, such as commissions and programs.

Further, routes to market are problematic. For OEMs there are high procurement costs, poor market price visibility, uncertain cost position vs. compensation, inability to forecast or fix component costs, exposure on bids, and exposure to cross media price changes; for distributors the market is highly fragmented, there are relatively high margins unrelated to value-add, and there is a temptation to game programs and price-protection; and for CSPs there is exposure to cross media price changes and inability to forecast or lock in future storage costs.

It would be advantageous to allow for the predictable purchase and sale of manufactured products, such as HDDs, in physical and derivative markets.

### SUMMARY

Disparate manufactured electronic products are reduced to a commodity component comprising a common, atomic functional value and a non-commodity component. Thus, a classic non-commodity is turned into a commodity. Manufactured electronic products, such as different models of HDDs produced by different manufacturers, that have disparate capacity, access times, and form factors are analyzed, and a common unit of functional value is produced for each such product, resulting in a technical commodity price index that allows for the purchase and sale of such technical commodities through physical and derivative markets.

Embodiments of the invention create two parallel markets for, manufactured devices such as HDD's, i.e. a physical market (spot, forward) and a derivatives market (futures, options). The devices are first characterized as technical commodities by starting with synthetic price indices which form the basis of a derivatives exchange. A capacity price index is developed, e.g. $/GB for rotating magnetic storage. The derivatives market is built once the indices are trusted. In embodiments of the invention, a physical market is initially established with distributors/CSP's and is expanded to OEM's over time.

While embodiments of the invention are discussed in connection with HDDs, those skilled in the art will appreciate that the invention is readily applied to other technical and manufactured components, such as NAND/SSD's (including cross-media “spreads” and “straddles”), LCD panels, DRAM, power supplies, etc.

Benefits that accrue across a value chain in connection with the herein disclosed invention include, for manufacturers, transparency in OEM and distributor pricing, accelerated market equilibrium adjustment of profit pools to value add, dramatic reduction in sales/marketing expenses, and demand visibility that lowers costs and improves margins.

HDD's are complex machines, filled with unique functionality. Thus, the problem to be solved in defining technical commodities, such as HDDs, is that of determining the common, atomic functional unit for a commodity portion of each of many disparate products. Embodiments of the invention recognize that most commodities are in fact mixes of the pure commodity and the unique feature. For example, aluminum is priced as weight of pure metal plus an adder for shape. In embodiments of the invention, manufactured electronic products, such as HDD's, can be thought of using a gas in a gas can model. Each gas can may be different in shape or construction, but the gas is always the same. Thus, for HDDs there is a base price for the container, including the form factor, hardware and firmware features, and warranty plus a variable price for the capacity, which can be thought of in $/GB

Embodiments of the invention produce synthesized capacity price indices, e.g. $/GB client, $/GB enterprise ≦7.2 k; $/GB enterprise ≧10 k. The synthetic capacity price is derived at first, directly observed when manufacturers adopt de-averaged pricing. The capacity price indices facilitate a derivatives (long-term futures) market. Specific product prices are the result of trades in the open, transparent market using a price publishing and discovery mechanism that is common to all open markets and that results from trades on an OTC spot/forward market. All true markets/exchanges have price discovery mechanisms. For example, if one wants to buy stock in Apple, he can go to Google, Yahoo, Bloomberg, etc. and get quotes for the price per share that represent the price of the last trade as published by NYSE, NASDAQ, etc. Other index examples include the S&P 500 Index, which is published by S&P and licensed by the Chicago Mercantile Exchange. The spot price for the S&P 500 index is calculated by taking the stock prices for the 500 companies in the index and weighting them according to S&P's proprietary formula. Anyone can see the current value of this index. The Chicago Mercantile Exchange has a futures and options market that uses this index, where traders essentially bet on what they think the index value will be at some set point in the future. These futures prices are published by the CME and are visible to anyone who subscribes to their pricing service, Google and Yahoo re-transmit the prices with a 15 minute delay, which costs far less than real-time quotes.

Key to the invention, for example for HDDs, is a mechanism that separates out capacity from form factor and functionality in pricing. Those skilled in the art will appreciate that a similar approach may be taken with any manufactured electronic product. For example, with regard to HDDs, instead of $150 for a 2 TB NL and $250 for a 4 TB NL, when the invention is applied, the price is quoted as $85+5¢/GB. Pricing in this manner appeals especially to the CSP's. If a 4 TB drive actually has 4.1 TB of usable capacity, this is valuable. HDD manufacturers no longer need to waterfall to next lower even capacity point or rework the drive, and can thus capture full value of the drive. This facilitates “Finish in the Field,” and is particularly suited to object drives and storage systems.

Embodiments of the invention also apply modifications to appeal to OEM's, e.g. a base drive+X¢/GB+“Even Capacity” adder.

### DRAWINGS

FIG. 1 is flow diagram showing a hard disk drive value chain;

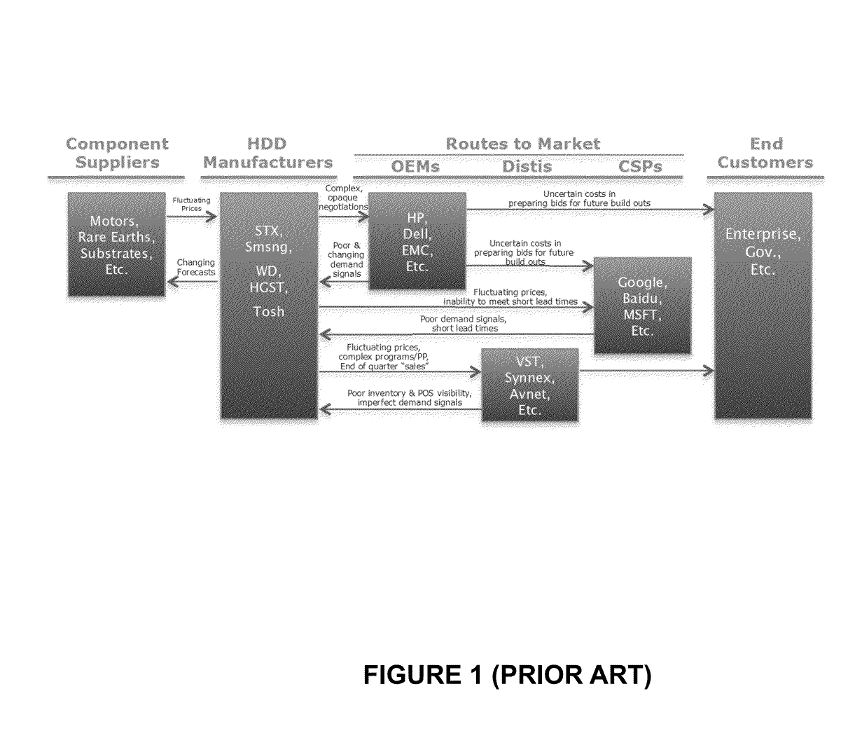

FIG. 2 is block schematic diagram showing a system for reducing disparate manufactured electronic products to a commodity component having a common, atomic functional value and a non-commodity component, and for creating a market therefor according to the invention;

FIG. 3 is block schematic diagram showing an extraction engine according to the invention;

FIG. 4 is a graph showing the determination of a synthetic capacity price index for a 3.5″ 7200 RPM HDD client according to the invention;

FIGS. 5A and 5B are graphs showing price variability over time;

FIG. 6 is a schematic diagram showing the evolution for price indices to market development according to the invention; and

FIG. 7 is a block schematic diagram showing a machine in the example form of a computer system within which a set of instructions for causing the machine to perform one or more of the methodologies discussed herein may be executed.

### DESCRIPTION

Disparate manufactured electronic products are reduced to a commodity component comprising a common, atomic functional value and a non-commodity component. Thus, a classic non-commodity is turned into a commodity. The prices of manufactured electronic products, such as different models of HDDs produced by different manufacturers, that have disparate capacity, access times, and form factors are analyzed, and a common unit of functional value is produced for each such products, resulting in a technical commodity price index that allows for the purchase and sale of such commodities through physical and derivative markets.

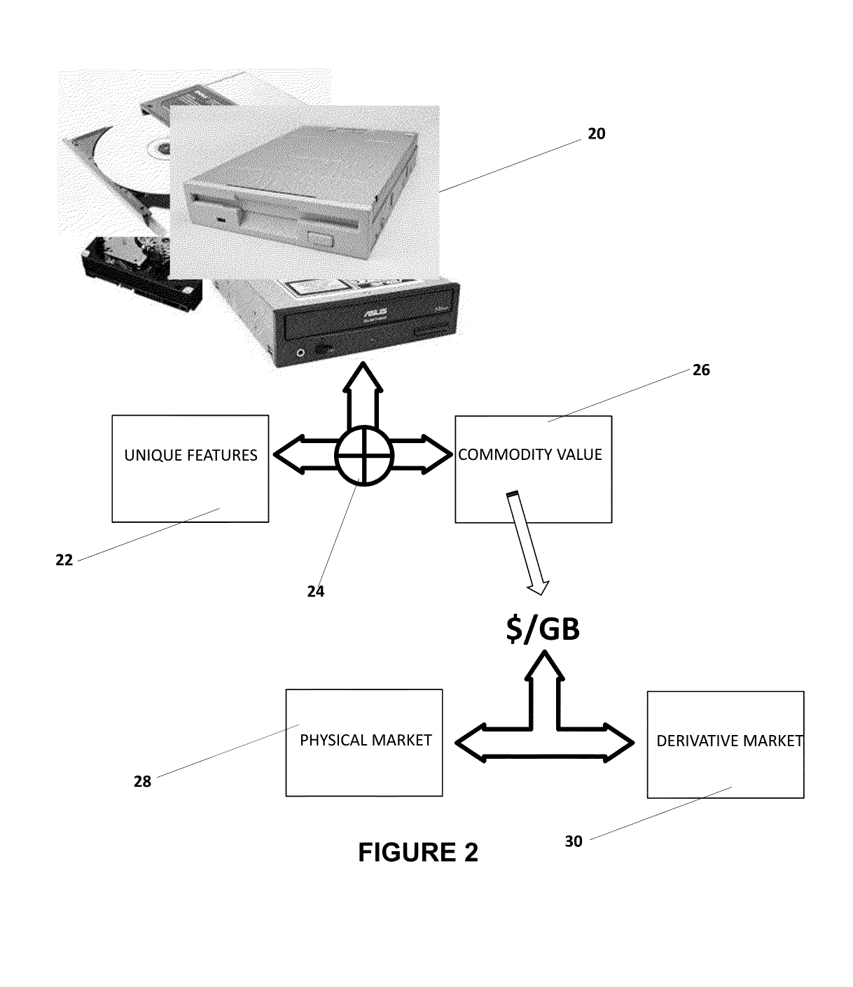

FIG. 2 is block schematic diagram showing a system for reducing the prices of disparate manufactured electronic products to a commodity component comprising a common, atomic functional value and a non-commodity portion, and creating a market therefor according to the invention. In FIG. 2, a plurality of disparate manufactured electronic goods, such as HDDs 20, provide the basis for determining a commodity value for a commodity portion of the product. Thus, a processor implemented method receives information regarding such products, including for example time-series data which is received from the manufacturers by category of product, e.g. 3.5″ PC client drives at 7200 RPM, including net price paid and the volume of product sold at that price for each capacity point, e.g. 500 GB, 1 TB, 2 TB, 3 TB, etc. An extraction engine 24 is applied to such information to produce a value for unique features of each of the products 22 and a value for the commodity portion of the products 26, the latter comprising a synthetic capacity price index that is expressed in $/GB in the case of HDDs.

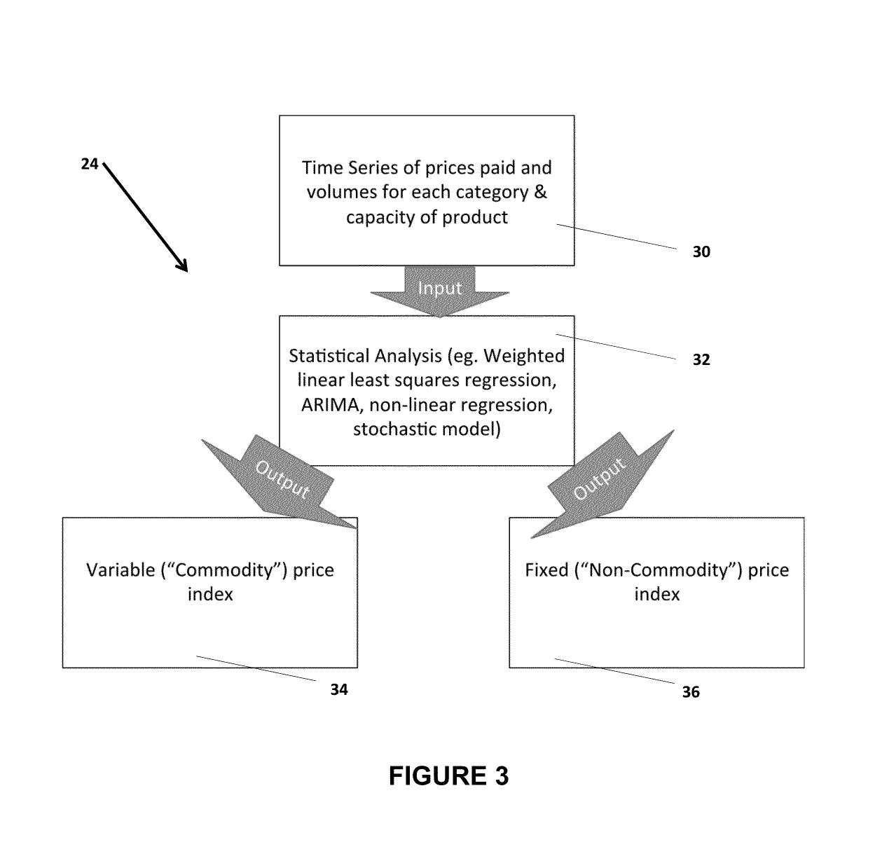

FIG. 3 is block schematic diagram showing an extraction engine 24 according to the invention. In FIG. 3, a time series of prices paid and volumes for each category and capacity of a product is provided as an input data set 30 (see Table 2). A statistical analysis module 32 employing, for example weighted least squares regression, autoregressive integrated moving average (ARIMA), non-linear regression, or a stochastic model, is applied receives the input data set and provides as an output both a variable, i.e. commodity, price index 34 and a fixed, i.e. non-commodity, price index 36.

TABLE 2
Sample Input Data Set

| Internal | | | | | | |
|---|---|---|---|---|---|---|
| Product | | | Market | Fiscal | | AUP |
| Nam | Capacity | Channel | S | Week | Units | (Net) |
| XXX | 1000 | OEM | CE | 8 | 1 | $28.62 |
| YYY | 250 | OEM | CE | 4 | 80 | $38.78 |
| YYY | 250 | OEM | CE | 26 | 19 | $38.75 |
| YYY | 250 | OEM | CE | 30 | 20 | $38.75 |
| YYY | 320 | OEM | CE | 8 | 20 | $38.75 |
| YYY | 500 | OEM | CE | 4 | 20 | $40.80 |
| YYY | 500 | OEM | CE | 8 | 20 | $38.78 |
| ZZZ | 1000 | DISTI | CE | 30 | 5 | $34.33 |
| ZZZ | 1000 | DISTI | CE | 4 | 2 | $30.97 |
| ZZZ | 1000 | DISTI | CE | 17 | 11 | $52.23 |
| ZZZ | 1000 | DISTI | CE | 34 | 1 | $59.68 |
| ZZZ | 1000 | DISTI | CE | 34 | 2 | $4.09 |
| ZZZ | 1000 | DISTI | CE | 4 | 2 | $63.00 |
| ZZZ | 1000 | DISTI | CE | 8 | 2 | $63.00 |
| ZZZ | 1000 | DISTI | CE | 26 | 1 | $65.00 |
| ZZZ | 1000 | DISTI | CE | 30 | 3 | $21.76 |
| ZZZ | 1000 | DISTI | CE | 4 | 1 | $80.60 |
| ZZZ | 1000 | DISTI | CE | 17 | 16 | $29.65 |
| ZZZ | 1000 | DISTI | CE | 8 | 3 | $23.74 |
| ZZZ | 1000 | DISTI | CE | 26 | 5 | $36.20 |
| ZZZ | 1000 | DISTI | CE | 26 | 43 | $61.02 |
| ZZZ | 1000 | DISTI | CE | 34 | 2 | $60.06 |
| ZZZ | 1000 | DISTI | CE | 17 | 105 | $46.41 |
| ZZZ | 1000 | DISTI | CE | 4 | 1 | $66.52 |
| ZZZ | 1000 | DISTI | CE | 21 | 5 | $62.17 |
| ZZZ | 1000 | DISTI | CE | 30 | 8 | $4.47 |
| ZZZ | 1000 | DISTI | CE | 4 | 2 | $66.52 |
| ZZZ | 1000 | DISTI | CE | 21 | 11 | $66.80 |
| ZZZ | 2000 | DISTI | CE | 30 | 4 | $22.96 |
| ZZZ | 2000 | DISTI | CE | 4 | 26 | $65.73 |
| ZZZ | 2000 | DISTI | CE | 34 | 4 | $36.77 |
| ZZZ | 2000 | DISTI | CE | 4 | 5 | $1,091.80 |
| ZZZ | 2000 | DISTI | CE | 4 | 1 | $92.37 |
| ZZZ | 2000 | DISTI | CE | 34 | 14 | $77.41 |
| ZZZ | 2000 | DISTI | CE | 8 | 1 | $65.03 |
| ZZZ | 2000 | DISTI | CE | 13 | 1 | $115.95 |
| ZZZ | 2000 | DISTI | CE | 26 | 2 | $62.59 |
| ZZZ | 2000 | DISTI | CE | 13 | 1 | $154.56 |
| ZZZ | 2000 | DISTI | CE | 30 | 10 | $47.60 |
| ZZZ | 2000 | DISTI | CE | 8 | 20 | $43.26 |
| ZZZ | 2000 | DISTI | CE | 21 | 6 | $57.22 |
| ZZZ | 2000 | DISTI | CE | 17 | 7 | $77.15 |
| ZZZ | 2000 | DISTI | CE | 8 | 6 | $46.21 |
| ZZZ | 2000 | DISTI | CE | 26 | 23 | $87.91 |
| ZZZ | 2000 | DISTI | CE | 34 | 7 | $81.64 |
| ZZZ | 2000 | DISTI | CE | 17 | 3 | $8.95 |
| ZZZ | 2000 | DISTI | CE | 4 | 6 | $1,006.75 |
| ZZZ | 2000 | DISTI | CE | 30 | 16 | $88.65 |
| ZZZ | 2000 | DISTI | CE | 26 | 1 | $290.47 |
| ZZZ | 2000 | OEM | CE | 17 | 1 | $66.75 |
| ZZZ | 2000 | OEM | CE | 4 | 9 | $120.00 |
| ZZZ | 2000 | OEM | CE | 17 | 1 | $89.00 |
| ZZZ | 2000 | OEM | CE | 34 | 7 | $62.19 |
| ZZZ | 2000 | OEM | CE | 8 | 1 | $90.00 |
| ZZZ | 3000 | DISTI | CE | 4 | 1 | $128.91 |
| ZZZ | 3000 | DISTI | CE | 30 | 3 | $72.48 |
| ZZZ | 3000 | DISTI | CE | 4 | 3 | $77.77 |
| ZZZ | 3000 | DISTI | CE | 39 | 10 | $10.44 |
| ZZZ | 3000 | DISTI | CE | 17 | 22 | $52.87 |
| ZZZ | 3000 | DISTI | CE | 30 | 3 | $55.37 |
| ZZZ | 3000 | DISTI | CE | 17 | 1 | $126.69 |
| ZZZ | 3000 | DISTI | CE | 13 | 32 | $93.87 |
| ZZZ | 3000 | DISTI | CE | 30 | 1 | $102.01 |
| ZZZ | 3000 | DISTI | CE | 34 | 2 | $54.87 |
| ZZZ | 3000 | DISTI | CE | 4 | 20 | $119.76 |

Once the invention is applied to creating technical commodities from manufactured electronic products, it is possible to create two new markets for these technical commodities, leveraging well established models, e.g. a derivatives exchange 30 (futures/options), modeled after the Chicago Mercantile Exchange, that is based on a set of synthetic capacity price indices ($/GB); and a physical exchange 28 (spot/forward), modeled after the NYSE, NASDAQ, Treasury Debt Auctions and Interest Rate Swap markets. See Table 3 below. While embodiments of the invention concern an HDD market, those skilled in the art will appreciate that the invention is readily extended to other manufactured electronic products, such as SSD/NAND flash, DRAMs, LCD displays, silicon wafers, etc.

Why Create these New Markets?

The technical commodity markets share most characteristics that drove other markets to futures and/or options exchanges, such as capital intensity, susceptibility to demand and supply shocks, need for accurate forecasts, etc. Inefficiencies and friction exist up and down the value chain that can be alleviated with open, transparent market mechanisms. The idea of a futures market was first described by Aristotle (“Politics”) and has been implemented and refined for centuries.

TABLE 3
Markets for Technical Commodities

| | Physical (Spot/Forward) Market | Derivative (Futures/Options) Market |
|---|---|---|
| Analogues | Fed auctions (T-Bonds, T- | Chicago Mercantile Exchange, |
| | Bills), SEFs, NYSE/NASDAQ | London Metals Exchange |
| Description | Transparent, open | Based on trusted, |
| | exchange trading | ubiquitous indices, e.g.: |
| | physical goods | Capacity price |
| | Spot (near-term), | ($/GB) |
| | Forward (future | Volume/TAM |
| | delivery) | Futures contracts |
| | Common attributes: | essentially a “bet” on the |
| | price discovery | direction of future price |
| | mechanism, regulated | moves until contract |
| | trading practices, fraud | expiration |
| | detection/surveillance | Options are essentially a |
| | Trades are between | “one way” bet that the |
| | buyer and seller (no | index will be above or |
| | clearinghouse) | below a certain value at |
| | | expiration |
| | | Standard contracts |
| | | Clearinghouse counter- |
| | | party to trades |
| Value | Efficiency: vastly | Facilitates hedging - |
| Creation | reduced transaction | “insurance” policy against |
| | costs, finer grained | price moves (“locking in” |
| | price moves (“ticks”) | future prices today) |
| | Transparency: bids and | Facilitates speculation - |
| | offers visible to all | enables pricing efficiency |
| | participants, visibility to | (any price aberrations will |
| | future demand | be arbitraged away) |
| | Robust: trades legally | Cross-commodity price |
| | binding & secured, | relationships can be |
| | dramatic reduction in | traded - a bet on future |
| | ability to “game” market | price relationships |

What will be the benefits to current market participants (see Table 4 below)?
HDD Suppliers: Price stability, transparent demand and supply visibility, better forecasting, lower sales and marketing cost, and better capital expenditure planning;
OEM Customers: Lock in prices for bids on future build-outs, future supply assurance, and price visibility;
Distributors: Longer term distributors would evolve into physical delivery agents and value added resellers.

TABLE 4
Benefits of Markets for Technical Commodities

| | Physical Spot/Forward | Derivative Futures/Options |
|---|---|---|
| | Market | Market |
| Sales/Marketing | Dramatic reduction | Far greater visibility to |
| | in sales & | future market trends |
| | marketing expense | Volume |
| | Reduction/elimination | Prices |
| | of program | Cross |
| | expense (rebates, | commodity |
| | price protection) | relationships |
| | Far greater in- | (e.g. |
| | quarter (Spot) & | SSD/HDD |
| | out-quarter | pricing) |
| | (Forward) visibility | Market share (“Exabyte |
| | Improved | share” by segment) |
| | competitive intel | in absence of HDDA |
| | Pricing becomes an | Facilitates “off- |
| | output rather than | capacity” pricing, |
| | input | reducing waterfall & |
| | | rework |
| Operations | Dramatic | Off-capacity pricing |
| | improvement in | enables “Finish-in- |
| | forecast accuracy | the-Field” & |
| | Improved production | reduction in waterfall |
| | planning & supply | Dramatically better |
| | chain management | future demand |
| | Channel for reducing | forecasting driving |
| | excess inventory | better CapEx |
| | Market “leveling” | planning |
| | could vastly reduce | With component |
| | number of SKU's | contracts (e.g. |
| | | motors, rare earth |
| | | elements), can lock |
| | | in future prices and |
| | | smooth out cost |
| | | swings |
| Finance/Admin | Fine-grained | Enables hedging |
| | visibility to in- | against adverse, |
| | quarter | unpredictable supply |
| | performance & | and demand shocks, |
| | competitive | smoothing future |
| | position | revenues |

Tactical benefits of the invention include, for example, improved market visibility, better forecast accuracy, better competitive intelligence, more reliable data to guide capital expenditures, the ability to hedge future quarters, forward sales can smooth out production and lead to better linearity through each quarter, and reduced sales and marketing expense.

Strategic benefits of the invention and associated impacts (see Table 5 below) include unbundled product and de-averaged pricing, reduced waterfall and rework, facilitates finish in the field, product homogenization, and exchange traded products are standard tab. As a percentage of sales through the exchange grows, SKU proliferation is reduced. The invention has the potential to reengineer sales and marketing massively. For example, the exchange can replace quarterly negotiations, ales can focus on relationship management rather than tactical execution, distribution is likely to be dramatically simplified. In embodiments of the invention, distributors are no longer able to rely on programs and price protection. Thus distributors are likely to evolve in one of four ways, i.e. begin adding value, consolidate, become traders on the exchange, or focus on other business.

TABLE 5
Impacts

| | | | Derivative | |
|---|---|---|---|---|
| | Physical Spot/Forward | | Futures/Options | |
| | Market | | Market | |
| OEMs | + | Transparency in | + | Enables hedging |
| | | pricing vs. | | against future |
| | | competition | | price moves (e.g. |
| | + | Ability to lock-in | | when bidding on |
| | | pricing & supply | | large future |
| | | in out-quarters | | build-outs) |
| | − | Dramatically | + | Transparency on |
| | | reduced ability to | | cross-media |
| | | game | | pricing |
| | | negotiations | | relationships |
| | ± | Reduced | | (e.g. SSD/HDD |
| | | procurement | | prices) |
| | | costs | | |
| CSPs | + | Transparency in | + | Enables hedging |
| | | pricing | | against future |
| | + | Ability to lock-in | | price moves |
| | | pricing & supply | | |
| | | for near & long- | | |
| | | term builds | | |
| Distis | − | Disruption in | + | Distis making |
| | | business model - | | transition to |
| | | would need to | | speculation will |
| | | add value (e.g. | | thrive |
| | | advice, | | |
| | | integration, | | |
| | | logistics, account | | |
| | | management) to | | |
| | | survive | | |
| | ± | Likely would | | |
| | | force | | |
| | | consolidation | | |
| Suppliers | + | Better demand | + | Better future |
| | | visibility | | demand visibility |

### Calculating Synthetic Capacity Price Indices

Key to the invention is a determination of the commodity portion of a manufactured electronic product. Once this is determined, then it is possible to create the markets discussed elsewhere herein. This is accomplished by dividing, e.g. HDD, prices into fixed and variable components (see FIG. 2).

### Generalized Least Squares

In statistics, generalized least squares (GLS) is a technique for estimating the unknown parameters in a linear regression model. The GLS is applied when the variances of the observations are unequal (heteroscedasticity), or when there is a certain degree of correlation between the observations. In these cases ordinary least squares can be statistically inefficient, or even give misleading inferences.

In a typical linear regression model we observe data {yᵢ, xᵢⱼ}_{i=1 . . . n,j=1 . . . p} on n statistical units. The response values are placed in a vector Y=(y₁, . . . , yₙ)′, and the predictor values are placed in the design matrix X=[[xᵢⱼ]], where xᵢⱼ is the value of the jth predictor variable for the ith unit. The model assumes that the conditional mean of Y given X is a linear function of X, whereas the conditional variance of the error term given X is a known matrix Ω. This is usually written as:

Y=Xβ+ε, E[ε|X]=0, Var[ε|X]=Ω.

Here β is a vector of unknown “regression coefficients” that must be estimated from the data.

Suppose b is a candidate estimate for β. Then the residual vector for b is Y−Xb. Generalized least squares method estimates β by minimizing the squared Mahalanobis length of this residual vector:

$$\hat{β} = {arg min}_{b} {( Y - Xb )}^{′} {Ω}^{- 1} ( Y - Xb ) ,$$

Because the objective is a quadratic form in b, the estimator has an explicit formula:

\hat{β}=(X′Ω⁻¹X)⁻¹X′Ω⁻¹Y.

Properties: The GLS estimator is unbiased, consistent, efficient, and asymptotically normal:

$$\sqrt{n} ( \hat{β} - β ) {\to }^{d} 𝒩 ( 0 , {( {X}^{′} {Ω}^{- 1} X )}^{- 1} ) .$$

GLS is equivalent to applying ordinary least squares to a linearly transformed version of the data. To see this, factor Ω=BB′, for instance using the Cholesky decomposition. Then if we multiply both sides of the equation Y=Xβ+ε by B−1, we get an equivalent linear model Y*=X*β+ε*, where Y*=B−1Y, X*=B−1X, and ε*=B−1ε. In this model Var[ε*]=B−1Ω(B−1)′=I. Thus, we can efficiently estimate β by applying OLS to the transformed data, which requires minimizing:

(Y*−X*b)′(Y*−X*b)=(Y−Xb)′Ω⁻¹(Y−Xb).

This has the effect of standardizing the scale of the errors and “de-correlating” them. Because OLS is applied to data with homoscedastic errors, the Gauss-Markov theorem applies, and therefore the GLS estimate is the best linear unbiased estimator for β.

### Weighted Least Squares

A special case of GLS called weighted least squares (WLS) occurs when all the off-diagonal entries of Ω are 0. This situation arises when the variances of the observed values are unequal, i.e. heteroscedasticity is present, but where no correlations exist among the observed variances. The weight for unit i is proportional to the reciprocal of the variance of the response for unit i. In embodiments of the invention, the weight used is the number of products sold at that price in the same transaction. For example, if in week 1 HP buys 1,000,000 500 GB 3.5″ desktop drives and pays $45/drive, and in the same week a distributor buys 1,000 of the exact same drives and pays $65/drive, the HP data point carries greater weight in the linear regression. This weighting is equivalent to taking each transaction and breaking it out into separate data points. In such case, the HP transaction, which is one line in the input file, could turn into 1,000,000 lines, all with the exact same price and capacity, and the distributor transaction could turn into 1,000 lines, all with the exact same price and capacity.

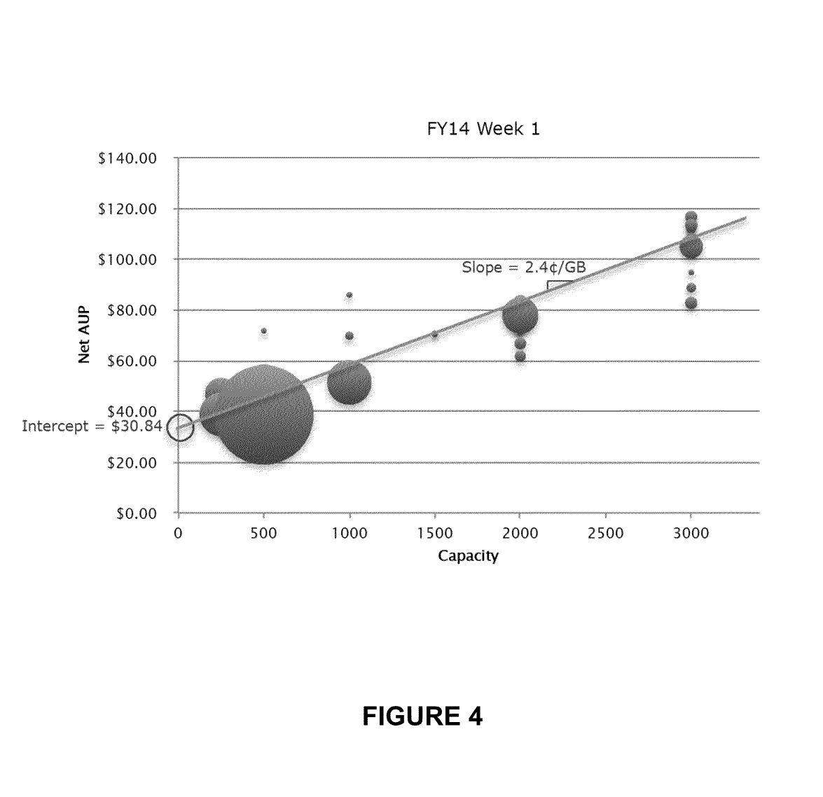

FIG. 4 is a graph showing the determination of a synthetic capacity price index for a 3.5″ 7200 RPM HDD client according to the invention. In an embodiment of the invention, this requires data that include weekly and/or daily volumes, capacities (in the case of HDDs), and net prices; segments (PC, NB, EC); and channel, e.g. distributor, OEM, CSP. The methodology applies a weighted least-squares linear regression, which when graphed has an intercept that is the fixed price of the product for a which a commodity price is to be established, e.g. the price of the HDD, and has a slope that is the variable price for the commodity portion of the product, e.g. $/GB. The variable price, or the Beta in the regression line, represents the price of the commodity portion of that product or, in other words, it is the commodity price index for that particular category of component

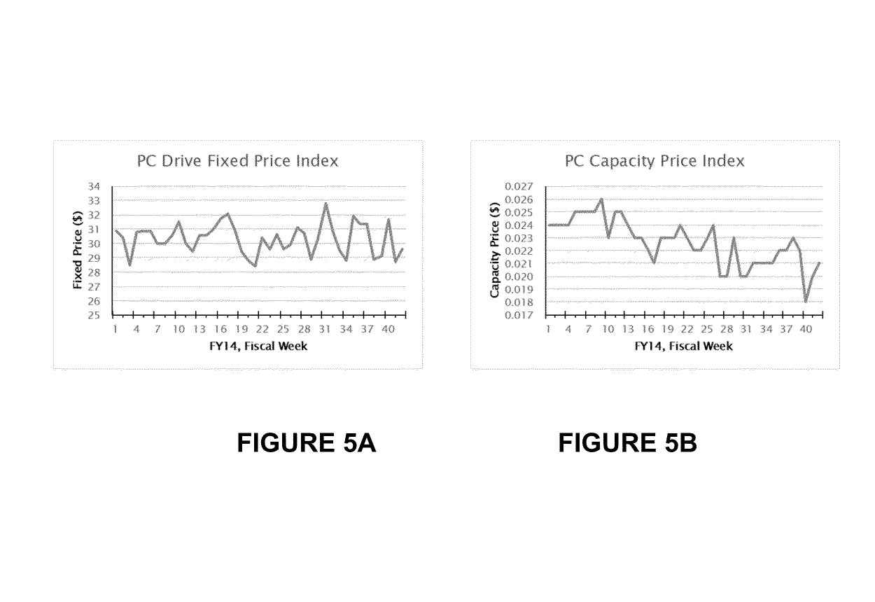

FIGS. 5A and 5B are graphs showing price variability over time, where initial analysis suggests that price erosions are largely due to reductions in the price per unit of capacity over time. FIG. 5A shows a fixed price index for PC HDDs, i.e. a non-commodity price, and FIG. 5B shows a capacity price index for PC HDDs, i.e. a commodity price Thus, a consumer of large quantities of HDD capacity, e.g. Each of FIGS. 5A and 5B show a time series of all purchases for certain HDDs over the course of 40 weeks on a week-by-week basis. For each week, a weighted regression is run. The y intercept is plotted as the fixed price index in FIG. 5A; the slope shows the commodity price index in FIG. 5B. The consumer of large quantities of HDD capacity, such as an enterprise that maintains large data centers, typically forecasts a capacity need. This is based upon actual storage capacity, for example in Gb, and not on the number of drives that are to be purchased. The invention provides an index that allows the purchase of capacity at a known price without regard to the actual price over time of individual HDDs. As such, it is possible to develop an index for competing technology, such as solid state drives (SSDs), and apply the HDD and SSD indices to hedge purchase across media types, buying HDDs when the index is more favorable for that media type and SSDs when the index is more favorable for that media type.

Refinements to the invention include, in various embodiments, a maximum capacity adder; even/odd capacity adjustments, such as an off capacity discount or an even capacity upcharge; lead time adjustments, such as an advanced purchase or linearity discount or a last minute late charge; and volume discounts.

Evolution from Price Indices to Market Development

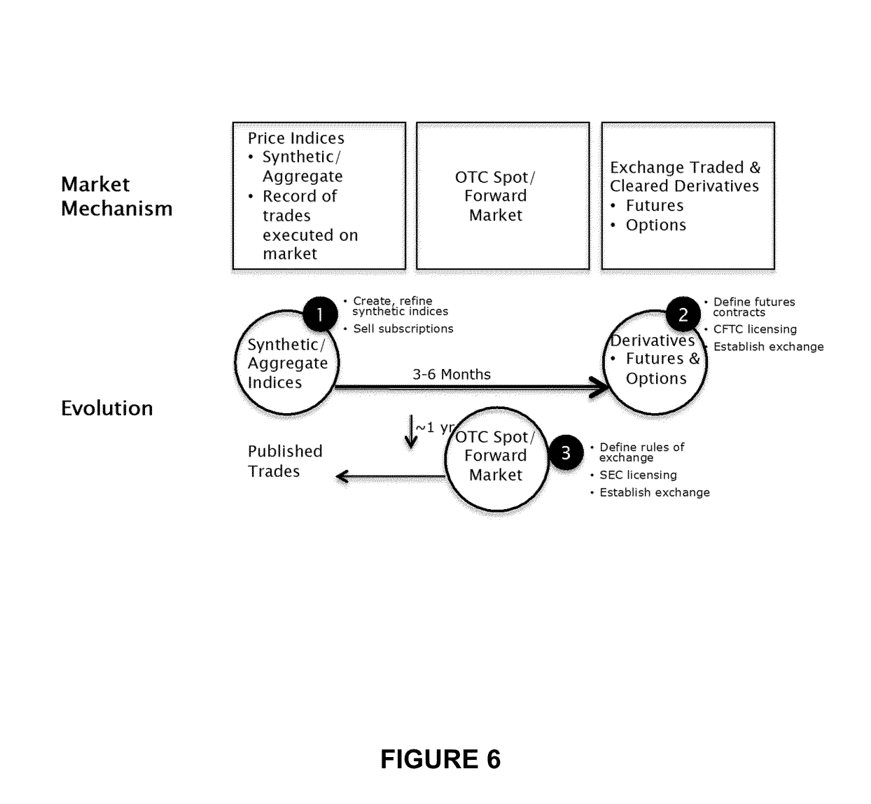

FIG. 6 is a schematic diagram showing the evolution for price indices to market development according to the invention. In FIG. 6, the market mechanism initially includes price indices that, over time, first evolve to derivative markets, such as futures and options markets and, thereafter to spot and forward markets. The invention allows the creation of these markets by providing, for example, HDDs that are characterized with regard to a commodity portion and a non-commodity portion, where the commodity portion is a common, atomic functional value of the HDD, e.g. expressed in a $/Gb index.

### Business Models

In embodiments of the invention, strong revenue drivers include price indices subscriptions; trading fees; spot/forward, such as a % of value; futures/options, such as a fee per contract; and a physical delivery fee to incentivize cash settlement.

Embodiments of the invention provide a capital efficient business model that is not labor intensive; that uses off-the-shelf technology with small customizations; and that uses outsourced services.

The markets described above can be served by various contracts, such as a futures contract (see Table 6 below).

TABLE 6
HDD Futures Contract

| | |
|---|---|
| Description | Monthly physical settled futures contract for Hard Disk |
| | Drives |
| Contract Size | 1,000 drives |
| Deliverable Grade | 5400 rpm 1TB disk drive with 3-year standard |
| | warranty to replace-on-failure* |
| Contract Security | Exchange acts as the central counterparty for trades |
| | conducted to guarantee up to and including delivery, |
| | exercise and/or settlement. |
| Daily Margin | All open contracts are marked-to-market daily. |
| Contract | Monthly with settlement in Day 15 of the month |
| Availability | |
| Settlement Basis | Cash Settlement with an option of physical delivery |
| | (for a fee), e.g. average spot price index over last |
| | 3 trading days prior to expiration of the contract |
| Delivery Process | Clearing House matches aggregate Buyer |
| | and Seller positions at maturity. Identity of matched |
| | Buyers and Sellers is shared with 1 week to arrange |
| | physical delivery according to standard Exchange |
| | rules, or to alternative arrangements agreed by |
| | mutual consent. |

*24-hour replacement in standard markets. Other warranty options available for premium or discount.

### Computer Implementation

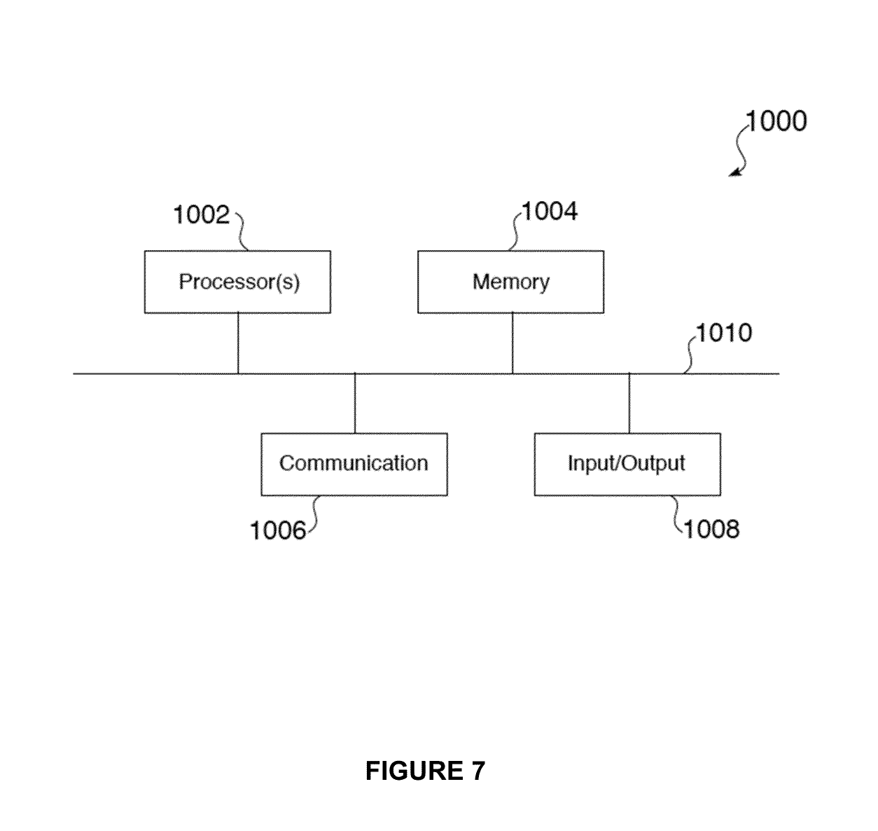

FIG. 7 is a block diagram of a computer system that may be used to implement certain features of some of the embodiments of the invention. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 40 may include one or more central processing units (“processors”) 45, memory 41, input/output devices 44, e.g. keyboard and pointing devices, touch devices, display devices, storage devices 42, e.g. disk drives, and network adapters 43, e.g. network interfaces, that are connected to an interconnect 46.

In FIG. 7, the interconnect is illustrated as an abstraction that represents any one or more separate physical buses, point-to-point connections, or both connected by appropriate bridges, adapters, or controllers. The interconnect, therefore, may include, for example a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also referred to as Firewire.

The memory 41 and storage devices 42 are computer-readable storage media that may store instructions that implement at least portions of the various embodiments of the invention. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 41 can be implemented as software and/or firmware to program one or more processors to carry out the actions described above. In some embodiments of the invention, such software or firmware may be initially provided to the processing system 40 by downloading it from a remote system through the computing system, e.g. via the network adapter 43.

The various embodiments of the invention introduced herein can be implemented by, for example, programmable circuitry, e.g. one or more microprocessors, programmed with software and/or firmware, entirely in special-purpose hardwired, i.e. non-programmable, circuitry, or in a combination of such forms. Special-purpose hardwired circuitry may be in the form of, for example, one or more ASICs, PLDs, FPGAs, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method, comprising:
with a processor, analyzing disparate manufactured electronic products to separate said manufactured electronic products into a commodity component comprising a common, atomic functional value and a non-commodity component;
said processor producing a common unit of functional value for each such product to identify a portion of said products unique to each said product and a commodity portion of each said product;
said processor establishing an index for said commodity portion of said products by characterizing said products as technical commodities via synthetic price indices; and
said processor applying said index to establish said products as a technical commodity for purchase and sale of said products through any of physical and derivative markets.

2. The method of claim 1, wherein manufactured electronic products comprise different models of HDDs produced by different manufacturers, that have disparate capacity, access times, and form factors.

3. The method of claim 1, wherein manufactured electronic products comprise any of NAND/SSD's, LCD panels, and DRAMs.

4. The method of claim 1, further comprising:
initially deriving a synthetic value for said commodity portion of said products by direct observation when manufacturers adopt de-averaged pricing.

5. The method of claim 4, further comprising:
using a price publishing and discovery mechanism to determine specific product prices as the result of trades in an open, transparent market.

6. The method of claim 1, further comprising:
applying a weighted least-squares linear regression, which when graphed has an intercept that is a fixed price of a product for a which a commodity price is to be established and that has a slope that is a variable price for the commodity portion of the product.

7. The method of claim 1, further comprising:
receiving time-series data from manufacturers of said products by category of product, including net price paid and volume of product sold at that price for each capacity point;
said processor extracting information from said data to produce a value for unique features of each of the products and a value for the commodity portion of the products, the value for the commodity portion of the products comprising the synthetic capacity price index.

8. The method of claim 7, further comprising:
providing said time series data as an input data set to said processor as prices paid and volumes for each category and capacity of a product;
said processor performing statistical analysis on said time series data using any of weighted least squares regression, autoregressive integrated moving average (ARIMA), non-linear regression, or a stochastic model; and
said processor providing as an output said synthetic capacity price index as a variable, commodity price index, and providing a fixed, non-commodity, price index.

9. A hard disk drive (HDD), comprising:
a non-commodity component; and
a commodity component, said commodity component having a common, atomic functional value that is established by applying a weighted least-squares linear regression which when graphed has an intercept that is a fixed price of said HDD for a which a commodity price is to be established and that has a slope that is a variable price for the commodity portion of the HDD.

10. The HDD of claim 9, further comprising:
establishing said common, atomic functional value by receiving time-series data from manufacturers of said HDDs by category of HDD, including net price paid and volume of HDD sold at that price for each capacity point; and
extracting information from said data to produce a value for unique features of each of the HDDs and a value for the commodity portion of the HDDs, the value for the commodity portion of the HDDs comprising the synthetic capacity price index.
